(19) United States
(12) Patent Application Publication
(10) Pub. No.: US 2025/0382227 A1
(43) Pub. Date: Dec. 18, 2025

(54) Sustainable Concrete Mixes with Negative Carbon Footprint Incorporating Carbon Black & Methods of Making

(71) Applicant: UNM Rainforest Innovations, Albuquerque, NM (US)

(72) Inventors: Mahmoud Reda Taha, Albuquerque, NM (US); Daniel Heras Murcia, Albuquerque, NM (US)

(73) Assignee: UNM Rainforest Innovations, Albuquerque, NM (US)

(21) Appl. No.: 19/240,974

(22) Filed: Jun. 17, 2025

Related U.S. Application Data
(60) Provisional application No. 63/661,031, filed on Jun. 17, 2024.

(51) Int. Cl. C04B 14/02; C04B 18/08; C04B 18/14; C04B 20/10; C04B 22/06; C04B 103/10; C04B 103/20; C04B 103/30; C04B 103/32; C04B 111/00

(52) U.S. Cl. CPC C04B 14/022; C04B 18/08; C04B 18/141; C04B 18/146; C04B 20/1074; C04B 22/064; C04B 2103/10; C04B 2103/20; C04B 2103/304; C04B 2103/32; C04B 2111/00017

(57) ABSTRACT

A concrete composition that incorporates carbon black sequestered from CO2.

### RELATED APPLICATIONS

This application claims priority to U.S. Provisional Application No. 63/661,031, filed on Jun. 17, 2024, which is incorporated herein in its entirety.

### FIELD OF THE INVENTION

The invention relates to building materials, particularly to concrete compositions that incorporate carbon black derived from sequestered CO2, enhancing sustainability and mechanical properties.

### BACKGROUND OF THE INVENTION

Traditional concrete production is a significant contributor to global CO2 emissions. The innovation of incorporating carbon black, especially derived from sequestered CO2, provides a pathway toward reducing these emissions and enhancing the mechanical properties of concrete.

### BRIEF SUMMARY OF THE INVENTION

In one embodiment, the present invention is to provide concrete with a low to negative carbon footprint and improved mechanical and durability properties, leading to a pathway toward sustainable infrastructure and carbon neutrality.

In another embodiment, the present invention uses carbon black sequestered from CO2 to create concrete with superior mechanical properties and a negative carbon footprint.

In another embodiment, the present invention uses carbon black sequestered from CO2 to create concrete that may be 3D printed.

In another embodiment, the present invention uses carbon black particles sequestered from CO2 that are chemically modified/surface activated using nanotechnology or other means to improve the mechanical properties, and durability characteristics or to allow 3D printing of concrete.

In another embodiment, carbon black concrete demonstrated low heat storage compared with conventional concrete mixes.

In another embodiment, the present invention uses carbon black sequestered from CO2 to create concrete that may be 3D printed enabling the design and creation of complex shapes and geometries that would otherwise not be possible with traditional casting methods.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The drawings, which are not necessarily drawn to scale, like numerals, may describe similar components throughout the several views. For example, numerals with different letter suffixes may represent different instances of similar components. The drawings illustrate, by way of example, but not by limitation, a detailed description of specific embodiments discussed in the present document.

FIG. 1 shows how Concrete mixes incorporating carbon black particles showed compressive strength over ˜4000 psi (30 MPa) similar to that of standard concrete.

FIG. 2 provides an exemplary means of designing concrete utilizing a carbon black particle size distribution wherein D0 is the minimum carbon black particle size and Dmax is the maximum carbon particle size.

FIG. 3 shows how the water retention of the carbon black is a function of its minimum particle size D0 and the particle size distribution.

FIG. 4 is a comparison of a carbon black concrete mixture compared to a conventional control concrete mix.

FIG. 5 provides calculations of the carbon footprint of the carbon black concrete of the present invention compared with the conventional concrete mix.

FIG. 6 shows how he carbon black concrete of the present can be produced to have a negative carbon footprint, by using the carbon black produced from sequestered CO2 such as the Noyes Process™.

FIG. 7 illustrates functional groups on the oxidized surface of carbon black for an embodiment of the present invention.

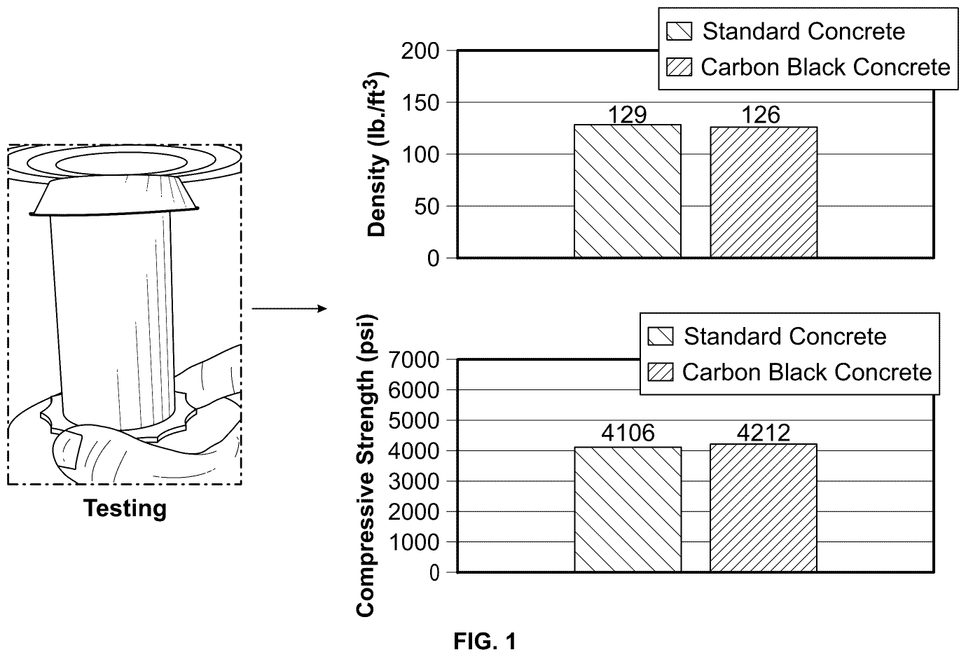

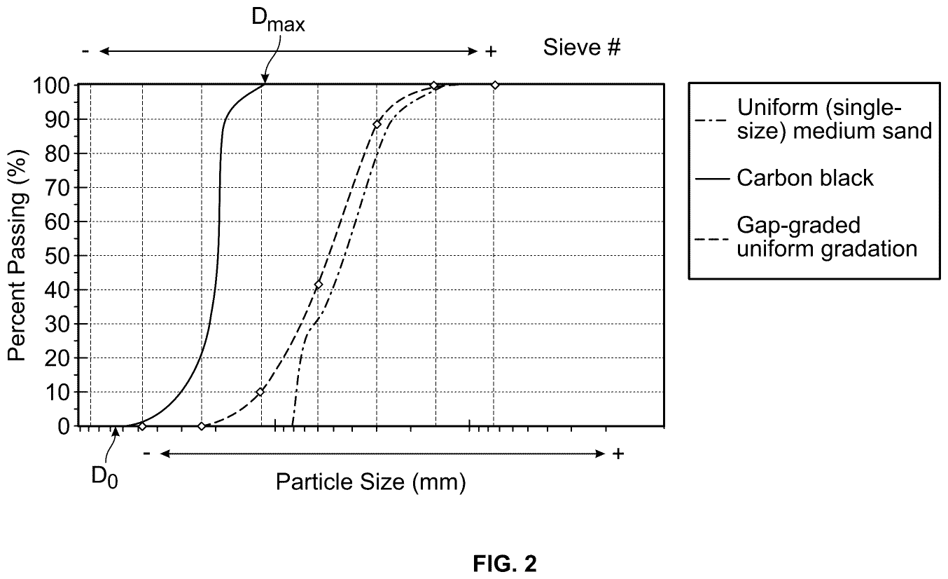

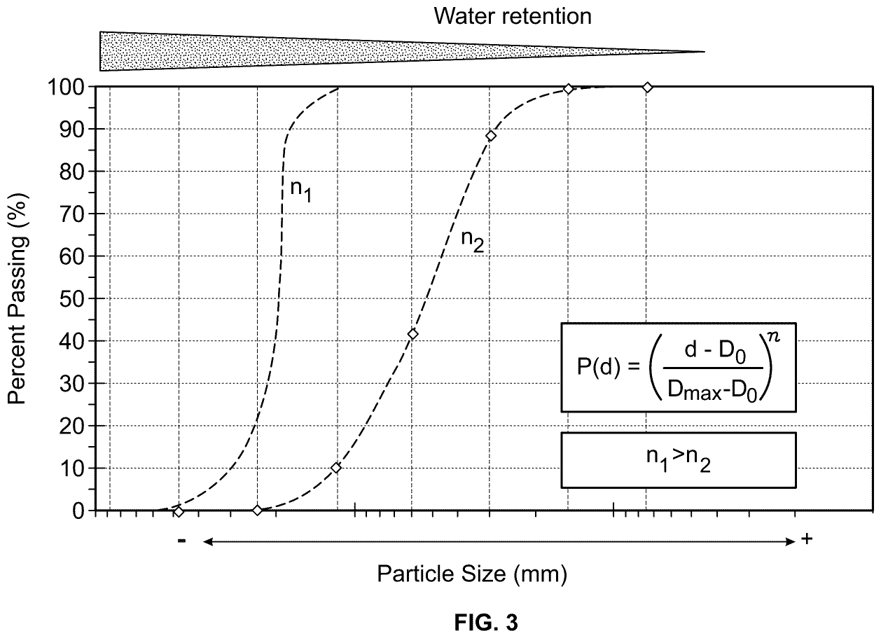

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

One embodiment of the present invention concerns concrete incorporating carbon black particles produced from sequestered CO2. Concrete mixes incorporating carbon black particles showed compressive strength over ˜4000 psi (30 MPa) which is very suitable for concrete structures and concretes used in numerous civil infrastructure applications.

In one embodiment of the present invention, a method of making concrete incorporating carbon black particles produced from sequestered CO2. The method involves the steps of determining the carbon black particle size and distribution for making concrete with appreciable strength and a negative carbon footprint.

In one embodiment of the present invention, the following formula is used for the design of carbon black particle size distribution.

$$P ( d ) = {( \frac{d - {D}_{0}}{{D}_{max} - {D}_{0}} )}^{n}$$

Where d is the carbon black particle size, D₀ is the minimum carbon black particle size and Dₘₐₓ is the maximum carbon particle size. The exponent n varies from 0.3 to 0.6 and is based on the type of aggregate that is blended with the carbon black particles. The values of Dₘₐₓ and D₀ are also based on the gradation of the aggregate to be blended with the carbon black particles. The carbon black tends to retain water which makes the flow

properties variable with time. This can affect concrete thixotropy and buildability and requires innovative mix design. The water retention of the carbon black is a function of its minimum particle size D₀ and the particle size distribution. The selection of the exponent n shall be made to reduce water r retention.

For applications with low concrete strength requirements (e.g., sidewalks), part of the binder (cement and pozzolans) in the concrete can be replaced with carbon black.

An Example carbon black concrete mixture is presented below and compared to a conventional control concrete mix.

Carbon black concrete can be mixed and handled using standard mixing and handling methods used with conventional concrete. No special admixtures need to be used. Superplasticizers as well as viscosity modifying agent admixtures can be used like their use with conventional concrete.

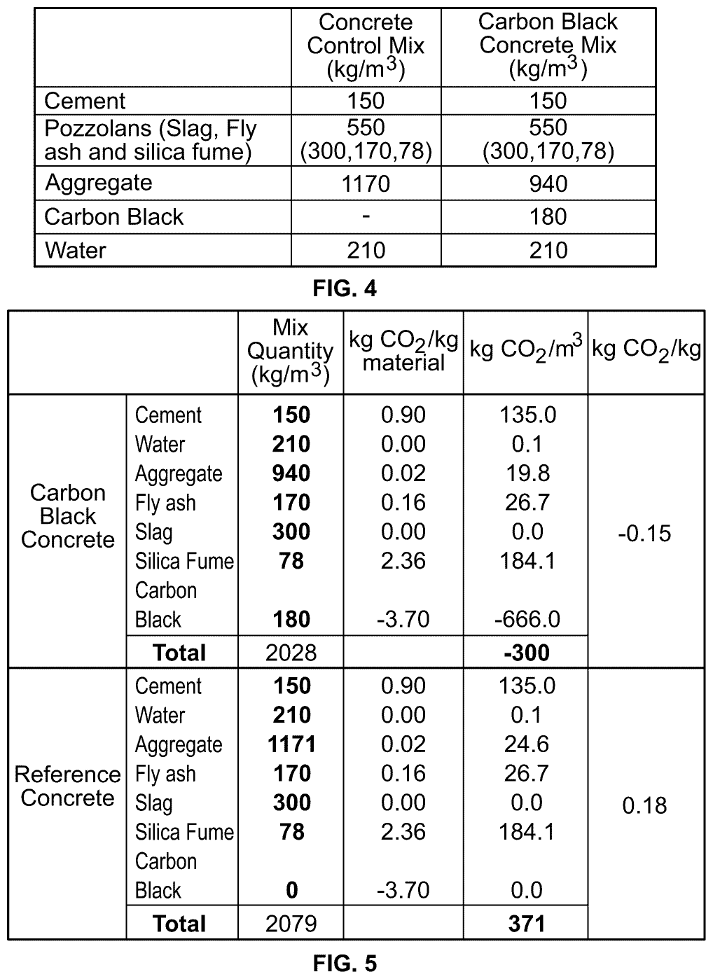

The carbon black concrete mix shown in FIG. 4 is one example mix that shows excellent mechanical properties, low heat storage and a negative carbon footprint. The invention is not limited to the above mix which is just presented as an example.

Concrete including carbon black has demonstrated low heat storage compared with conventional concrete mixes. In one embodiment, the present invention provides a concrete incorporating carbon black sequestered from CO2 wherein the mixture includes one or more of the following: cement, pozzolans such as fly ash, slag, silica fume, aggregate, carbon black, and water. In a preferred embodiment, the present invention provides a concrete

incorporating carbon black sequestered from CO2 wherein the mix quantity (kg/m³) includes the following: cement (150), fly ash (170), slag (300), silica fume (78), aggregate (940), carbon black (180), and water (210). As shown in FIG. 5, this embodiment of the present invention has a negative carbon footprint as compared with the conventional concrete mix.

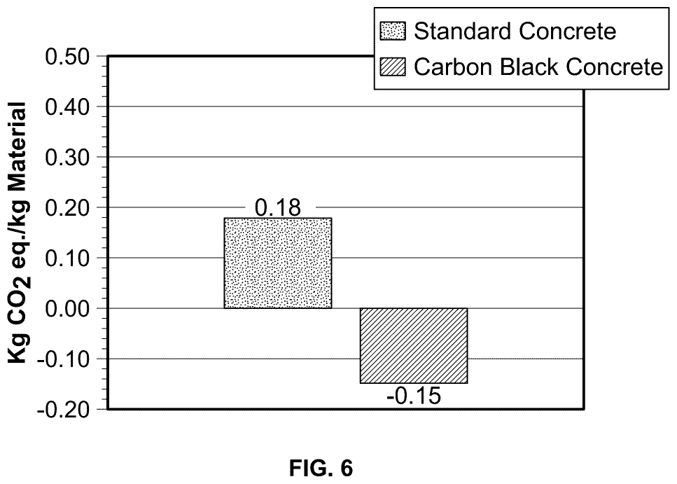

As shown in FIG. 6, the carbon black concrete of the present invention can be produced to have a negative carbon footprint, by using the carbon black produced from sequestered CO2 such as the Noyes Process™. As a result, the main feedstock in the CO2-sequestered carbon black is abundantly available as a byproduct from many industrial processes. The second input to the sequestration process is either hydrogen gas (H2) or methane (CH4). Through a multi-step process in a heated, pressurized vessel, these reactants produce solid carbon black (e.g., Noyes Carbon™) and distilled water. While the above is not part of this invention, it is necessary to mention it as it makes the carbon black source with a negative carbon footprint.

In another embodiment of the present invention, the surface of the carbon black particles from the CO2 sequestration can be chemically functionalized to exhibit pozzolanic properties further enabling reducing the amount of cement in the mix. Functionalized carbon black, with chemical functional groups can react with the calcium hydroxide produced during cement hydration in the conventional concrete mix, forming additional cementitious compounds. This process enhances the concrete's strength and durability while reducing the overall cement content, contributing to a lower carbon footprint.

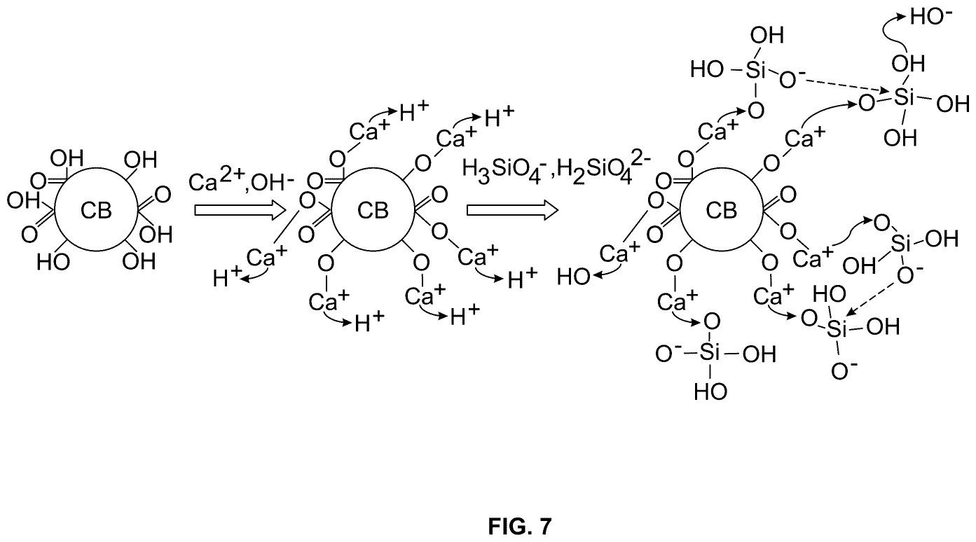

The potential functional groups on the oxidized surface of carbon black are illustrated in FIG. 7. The proposed reaction will lead to creating active silica groups bonded to the surface of carbon black. This reactive silica group will react with the free calcium hydroxide developed during cement hydration. This reaction will develop a strong carbon black-calcium-silicate-hydrate compounds that can improve concrete strength and long-term durability.

The central illustration of FIG. 7 depicts the chemisorption of calcium ions on the carbon surface. Lastly, the right side of FIG. 7 shows the formation of a silica active layer on the carbon black surface.

To further enhance the 3D printing capabilities and the mechanical properties of carbon black concrete, an embodiment of the present invention involves the functionalization of carbon black particles using surface charging. Introducing surface charges to the carbon black particles can improve the electrostatic bond between layers, leading to stronger interlayer adhesion. This can be achieved through methods such as plasma treatment or the addition of surfactants. These modifications not only facilitate the 3D printing process by enhancing both the electrostatic and chemical cohesion between successive layers but also improve the speed of hardening and overall buildability of the concrete.

In the context of 3D printing, carbon black concrete offers significant advantages due to its rheological properties and buildability. The fine particle size distribution of carbon black enhances the thixotropic behavior of the concrete, allowing for better shape retention and layer adhesion during the printing process. Additionally, the inherent water retention capability of carbon black can be controlled to optimize the workability and flow of the concrete mix, preventing issues such as sagging and deformation of printed layers. This controlled water retention not only improves the extrusion process but also contributes to the overall structural integrity and precision of 3D printed structures.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. A concrete composition that incorporates carbon black sequestered from CO2 comprising: cement, pozzolans, aggregate, carbon black, and water.

2. The concrete composition of claim 1 wherein the mix quantity (kg/m³) includes the following: cement (150), pozzolans (550), aggregate (940), carbon black (180), and water (210).

3. The concrete composition of claim 2 wherein the mix quantity (kg/m³) of said pozzolans is fly ash (170), slag (300), silica fume (78).

4. The concrete composition of claim 3 wherein the carbon black is functionalized with free silica to exhibit pozzolanic properties.

5. The concrete composition of claim 3 wherein the carbon black includes surface modifications by allowing the carbon black to react with calcium hydroxide.

6. A method of making a concrete composition that incorporates carbon black sequestered from CO2 comprising the steps of: mixing cement, pozzolans, aggregate, carbon black, and water together to create a mix quantity wherein the resulting concrete composition has a reduced carbon footprint.

7. The method of claim 6 wherein the mix quantity (kg/m³) includes the following: cement (150), pozzolans (550), aggregate (940), carbon black (180), and water (210).

8. The method of claim 7 wherein the mix quantity (kg/m³) of said pozzolans is fly ash (170), slag (300), silica fume (78).

9. The method of claim 8 wherein the carbon black is functionalized with free silica to exhibit pozzolanic activity with the cement.

10. The method of claim 9 wherein the carbon black includes surface modifications by allowing the carbon black to react with calcium hydroxide in the cement.

11. The concrete composition of claim 1 further including one or more additives.

12. The concrete composition of claim 11 wherein said one or more additives is a superplasticizer.

13. The concrete composition of claim 11 wherein said one or more additives is a retarder.

14. The concrete composition of claim 11 wherein said one or more additives is an accelerators.

15. The concrete composition of claim 11 wherein said one or more additives is an air entraining admixture.
